(19) United States
(12) Patent Application Publication
(10) Pub. No.: US 2024/0311272 A1
(43) Pub. Date: Sep. 19, 2024

(54) TEST CHECKING OF PULL REQUEST CHANGES USING LARGE LANGUAGE MODEL

(71) Applicant: MICROSOFT TECHNOLOGY LICENSING, LLC., REDMOND, WA (US)

(72) Inventors: MAX SCHAEFER, KIDLINGTON (GB); ALBERT ZIEGLER, UPPSALA (SE)

(21) Appl. No.: 18/198,018

(22) Filed: May 16, 2023

Related U.S. Application Data
(60) Provisional application No. 63/452,667, filed on Mar. 16, 2023.

(51) Int. Cl. G06F 11/36; G06N 5/022

(52) U.S. Cl. CPC G06F 11/3608; G06F 11/3676; G06F 11/3696; G06N 5/022

(57) ABSTRACT

A large language model, trained on source code and natural language text, predicts the testworthiness of a change in a pull request of a code repository. A prompt given to the large language model includes a question and an answer format for the model to predict whether a unit test is needed for the change. The question describes the model's task, the changes made to the file, and the contents of the changed file. When the model predicts that the change requires a unit test, a check is made to determine if the test exists. A comment is inserted into the pull request indicating the testworthiness of the change and whether a unit test exits for the test.

### CROSS-REFERENCE TO RELATED APPLICATIONS

The present application claims the benefit of the earlier filed provisional application having Ser. No. 63/452,667 filed on Mar. 16, 2023, entitled “AI Driven Test Checking”, which is incorporated by reference in its entirety.

### BACKGROUND

A version-controlled code repository stores each version of an artifact, such as a source code file, test file, documentation file, etc. and tracks the changes between the different versions. Repositories managed by a version-control system are often distributed so that each user of the repository has a working copy of the repository. The version-control system coordinates the distribution of the changes made to the contents of the repository to the different users.

When the user is finished with editing a source code file, the user performs a commit which checks in the modified version of the file back into a shared file repository. A pull request informs others that changes have been made to the file which were pushed or committed back into the repository.

A common practice is for the changes to be tested prior to being submitted and for the tests to be included in the pull request. Some repositories enforce unit testing by computing a test coverage measure that is based on a percentage of lines run in unit tests. If the suggested code change fails to meet a test coverage threshold, then the pull request is rejected.

However, at times, test coverage based on the percentage of lines run in unit tests is counterproductive since not all changes need to be tested. Small changes, changes that are difficult to test, or changes that are incidental to the functionality to the code often do not need to have added tests. Test coverage requirements in some cases delay and unnecessarily burden the code review cycle.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An automated system detects the testworthiness of a change in a pull request and checks for unit tests to cover the change when the change is testworthy. A change may be a newly-created file or the change may alter the contents of a file. The testworthiness is predicted by a large language model trained on natural language text and source code. The model makes the prediction given a prompt that includes a question and an answer format of the expected response. Upon the change being predicted as testworthiness, a check is made for an existing unit test to test the change. The prediction and the existence of the unit test is noted in the pull request.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary system of determining the testworthiness of a code change using a large language model.

FIG. 2 illustrates an exemplary prompt to a large language model to determine the testworthiness of a new file.

FIG. 3 is a flow chart illustrating an exemplary method of determining the testworthiness of a code change.

FIG. 4 is a block diagram illustrating an exemplary operating environment.

### DETAILED DESCRIPTION

### Overview

The subject matter disclosed pertains to predicting the testworthiness of a change to a file of a version-controlled source code repository using a large language model. A testworthy change is a change that needs to be tested. Not all changes in a pull request need to be tested. Small changes, changes that are difficult to test, changes that are incidental to the functionality to the code, such as changes to code comments or code formatting changes, or changes that affect a command-line interface do not need added tests. Software bug fixes should be tested in order to ensure that the bug does not occur again. The techniques described herein utilize a large language model to predict the necessity of testing a change identified in a pull request. The large language model is trained on an extensive training dataset of natural language text and source code to learn patterns in the data which is used to predict whether a change needs to be tested.

In an aspect, the technique is applied to a newly-created file and changes that alter the contents of an existing file. Changes that delete a file are never considered testworthy. The technique generates a prompt to the large language model containing the necessary context for the large language model to predict the testworthiness of a newly-created file or the testworthiness of the changes made to an existing file.

There are a variety of tests that may be applied to changes of a program, such as without limitation, a unit test, an integration test, a regression test, an acceptance test, a smoke test, and a security test. A unit test is a way of testing a smallest unit of code that can be logically isolated in a program. An integration test is a way of testing a set of software modules as a group. A smoke test is a way to test the overall functionality of a program. Regression testing re-runs functional and non-functional tests after changes to ensure that the program behaves as intended. Acceptance testing ensures that the business requirements of an end-user are met. In an aspect, the changes of a pull request are tested using a unit test.

Attention now turns to a system, device, and method of the test checking system.

### System

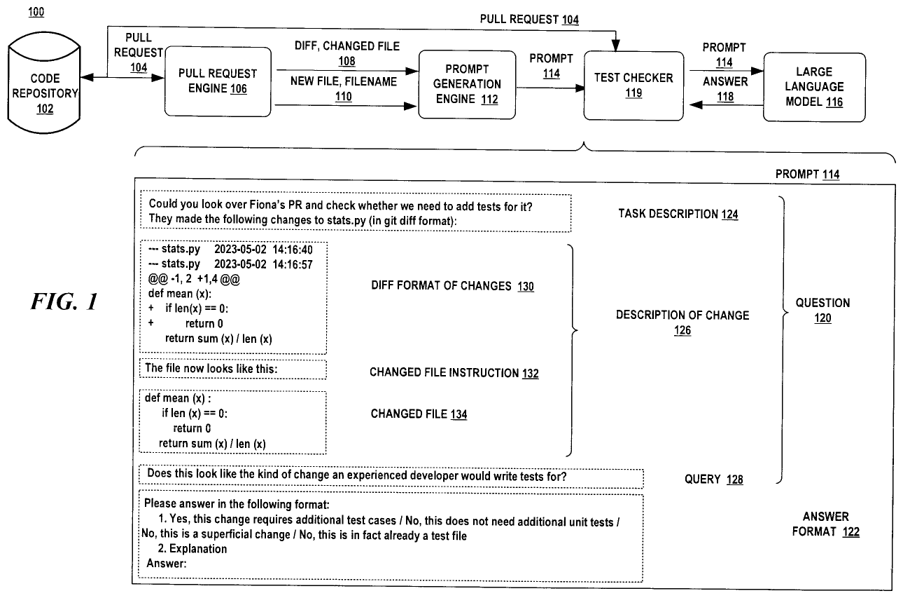

FIG. 1 represents an exemplary system 100 for predicting the testworthiness of a change from a pull request. The system 100 includes a code repository 102, a pull request engine 106, a prompt generation engine 112, a large language model 116, and a test checker 119. The pull request engine 106 interacts with a code repository 102 detecting pull requests 104 having commits that identify changes to an existing file or the creation of a new file.

A code repository 102 may be a file archive and web hosting facility that stores large amounts of software development assets, such as, without limitation, source code files, unit tests, script files, documentation, etc., either privately or publicly. A code repository 102 can be structured as a version control system, such as GIT, Mercurial, etc. The files residing in the code repository 102 vary and may be written in different programming languages.

The pull request engine 106 scans each pull request 104 uploaded to the code repository 102. If the pull request 104 indicates the creation of a new file, the pull request engine 106 extracts the new file and filename 110 from which the prompt generation engine 112 creates a prompt 114 for the large language model 116. If the pull request 104 indicates changes to an existing file, the pull request engine 106 extracts the diff of each change and the changed file from the code repository 102. The prompt generation engine 112 creates a prompt 114 for the large language model 116 from the diff of the changes and the changed file 108.

A diff is a utility program that compares the difference between two files. The diff program is used to show the difference between two versions of a file, such as the file before changes are made and the file with the changes. For example, the Git diff is a command that runs a function on Git data sources, such as commits, branches and files to show changes. The output of the diff program is a diff file showing the changes in a diff format. The diff format includes characters, ‘+’, that mark additions to the files, and characters, ‘−’, that mark deletions made to the file.

In an aspect, the large language model 116 is a neural transformer model with attention. A neural transformer model with attention is one distinct type of machine learning model. Machine learning pertains to the use and development of computer systems that are able to learn and adapt without following explicit instructions by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks. Neural transformers models are one type of deep learning that utilizes an attention mechanism. Attention directs the neural network to focus on a subset of features or tokens in an input sequence thereby learning different representations from the different positions of the tokens in an input sequence. The neural transformer model handles dependencies between its input and output with attention and without using recurrent neural networks (RNN) (e.g., long short-term memory (LSTM) network) and convolutional neural networks (CNN).

There are various configurations of a neural transformer model with attention. In an aspect, the large language model is configured as an encoder-decoder neural transformer model with attention. An encoder-decoder neural transformer model with attention consists of a series of stacked encoder blocks coupled to a series of stacked decoder blocks. The encoder blocks extract features from an input sequence to generate embeddings for each token in the input sequence, and the decoder uses the features to produce an output sentence representing repair code candidates. In another aspect, the large language model may be a decoder neural transformer model with attention having only decoder blocks.

The large language model is pre-trained on natural language text and source code. Examples of neural transformer models with attention include OpenAI's Codex, and other neural transformer models with attention offered by OpenAI, Google, Facebook, and Microsoft. In an aspect, the large language model is hosted on an external server and accessed over a network through application programming interfaces (API). The training of a large language model requires a considerable amount of training data and computing resources which makes it impossible for some developers to create their own models. Instead, third-parties having created a large language model may offer access to the large language model as a cloud service to developers with or without a fee.

A context window is the number of tokens that the large language model can process in a forward pass. The tokens represent the natural language text and source code contained in the prompt. The size of a context window varies and may include 4096 tokens, such as with OpenAI's Codex, to 32,000 tokens for OpenAI's GPT-4 model. The prompt is constrained by the size of the context window of the large language model.

The prompt generation engine 112 creates a prompt 114 for changes made to a source code file. In an aspect, the prompt may be formatted in a conversational manner that includes a question 120 and an answer format 122. The question 120 includes a task description 124, a description of the change made to the file 126, and a query 129. The task description 124 gives the model background information on the nature of the task and is in natural language. The task description 124 is followed by the diff file showing the changes made to the file 130, a changed file instruction 132 and the contents of the changed file 134. The changed file instructions indicate that the contents of the changed file are included in the prompt.

The query 128 is a natural language instruction on the task to be performed and is immediately followed by the answer format 122. The answer format instructs the model to provide a response in the desired format and the last line of the prompt is the phrase “Answer:”.

In an aspect, the model may return a single numeric value that is the log probability of the token ‘Yes’. A threshold is used to determine whether the numeric value represents a ‘Yes’ or a ‘No.’

It should be noted that the wording of the prompt is not constrained to the exact wording shown in prompt 114. Other question and answer formats may be used. For example, the answer format may consist of a simple Yes or No without any explanation. Additionally, the answer format may request that the model return a completion and check if it starts with the word “Yes” instead of returning a log probability.

The test checker 119 receives the answer 118 from the large language model 116. When the answer indicates that the change is testworthy, the test checker 119 examines the pull request to see if an existing test exists for the change. If no such test exists, then the test checker posts a comment in the pull request suggesting that a test for the change be created. Alternatively, the test checker can raise an alert in the code repository for the developer to add a test for the change. Alternatively, the test checker may invoke another application or system to create test suggestions which are posted into the pull request.

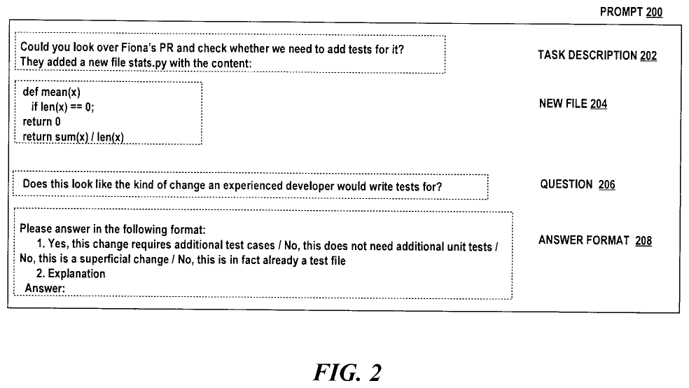

FIG. 2 is an illustration of an exemplary prompt for the scenario where the change is the creation of a new file. The prompt includes 200 includes a task description 202, the newly created file 204, a question 206 and an answer format 208. The task description 202 gives the model background information on the nature of the task and is in natural language. The contents of the newly created file are included in the prompt or portions of the file if the file is too long. The question 206 instructs the model on the target task and the answer format 208 instructs the model on the expected output of the question.

In some cases, the newly-created file may be rather large and the entire contents may not fit within the constraints of the context window size of the large language model. In this situation, portions of the file considered less important are replaced with a replacement string while portions of the file considered important are included in the prompt.

### Methods.

Attention now turns to a description of the various exemplary methods that utilize the system and devices disclosed herein. Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

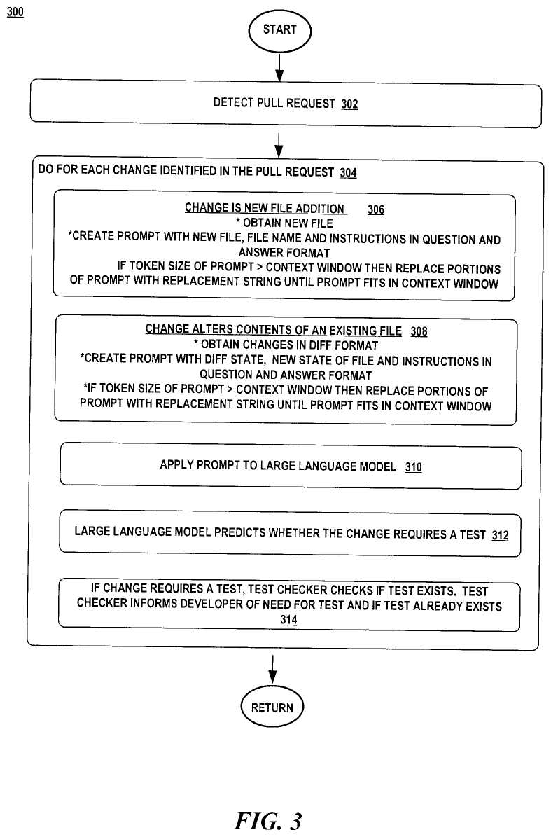

FIG. 3 is a flow chart of a method 300 for determining the test worthiness of a change in a pull request using a large language model. Referring to FIGS. 1-3, the pull request engine 106 detects a pull request submitted to the code repository 102 (block 302). The pull request 104 includes one or more changes to a file of the code repository. Each change identified in the pull request is processed (block 304).

If the change pertains to a newly-created file (block 306), then the new file is obtained. The new file is converted into tokens. A prompt is then created in a question-answer format with the contents of the new file, the new filename, and instructions for the model. The number of tokens of the prompt has to fit within the size of the context window of the large language model. If the token size of the prompt exceeds the context window size, then the prompt is analyzed to replace portions that are not deemed important with a replacement string until the size of the new file fits within the context window.

If the change pertains to changes made to an existing file (block 308), then the prompt generation engine obtains the diff file of the changes and the changed file. A prompt is generated that includes a task description, the diff file of the changes, the contents of the changed file, the question and the answer format (block 308). The number of tokens of the prompt has to fit within the size of the context window of the large language model. If the token size of the prompt exceeds the context window size, then the prompt is analyzed to replace portions that are not deemed important with a replacement string until the size of the new file fits within the context window.

The prompt is then applied to the large language model (block 310). In an aspect, the large language model is hosted on an external server and accessible through various application programming interfaces (APIs). The test checker 119 transmits the prompt through an API and receives a response (block 312). The response indicates Yes, that a test is required or No, a test is not required. In some cases, the model may respond with an explanation as well.

The test checker 119 receives the response and looks for an existing test for the change if the model predicts that the change is testworthy (block 314). If the test exists, the test checker 119 may insert a comment in the pull request indicating the need for the test and if a test exists, comment that an existing test is available. Alternatively, the test checker may inform the developer in any other way possible using the pull request or visually through a user interface of the code repository. Alternatively, the test checker collaborates with another application or system to create test suggestions which are forwarded to the pull request.

### Exemplary Operating Environment

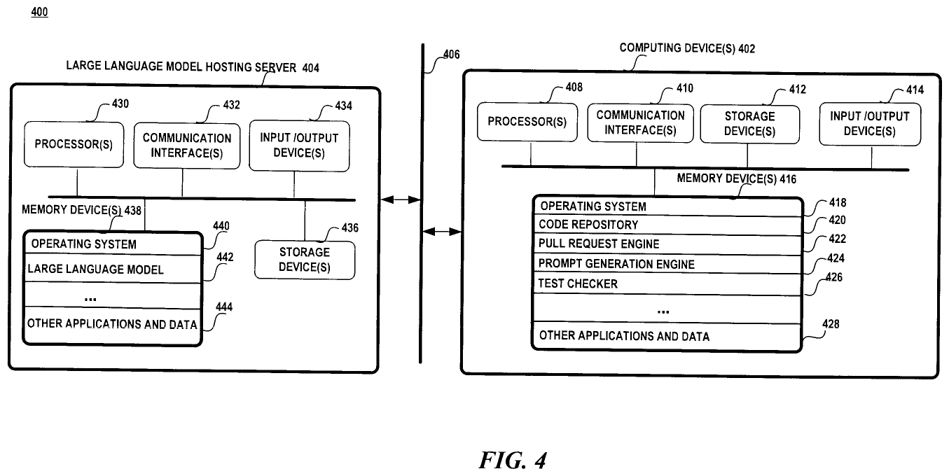

Attention now turns to a discussion of an exemplary operating environment. FIG. 4 illustrates an exemplary operating environment 400 in which one or more computing devices 402 are used to generate the prompt to the large language model and one or more computing devices 404 are used to host the large language model which uses the prompt to predict a response. However, it should be noted that the aspects disclosed herein is not constrained to any particular configuration of devices. In another aspect, a single computing device may host the large language model and generate the prompt from the changes of a pull request.

A computing device 402, 404 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 400 may be configured in a network environment, a distributed environment, a multi-processor environment, or a stand-alone computing device having access to remote or local storage devices.

The computing device 402, 404 may include one or more processors 408, 430, one or more communication interfaces 410, 432, one or more storage devices 412, 432, one or more input/output devices 414, 434, and one or more memory devices 416, 438. A processor 408, 430 may be any commercially available or customized processor and may include dual microprocessors and multi-processor architectures. A communication interface 410, 432 facilitates wired or wireless communications between the computing device 402, 404 and other devices. A storage device 412, 436 may be a computer-readable medium that does not contain propagating signals, such as modulated data signals transmitted through a carrier wave. Examples of a storage device 412, 436 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 412 in a computing device 402, 404. The input/output devices 414, 434 may include a keyboard, mouse, pen, voice input device, touch input device, display, speakers, printers, etc., and any combination thereof.

A memory device or memory 416, 438 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 416, 438 may also include one or more external storage devices or remotely located storage devices that do not pertain to propagated signals, such as modulated data signals transmitted through a carrier wave.

The memory device 416, 438 may contain instructions, components, and data. A component is a software program that performs a specific function and is otherwise known as a module, program, component, and/or application. The memory device 416 may include an operating system 418, a code repository 420, a pull request engine 422, a prompt generation engine 424, a test checker 426, and other applications and data 428. The memory device 438 may include an operating system 440, a large language model 442, and other applications and data 444.

A computing device 402 may be communicatively coupled via a network 406. The network 406 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 406 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Technical Effect

Aspects of the subject matter disclosed herein pertain to the technical problem of determining whether a change in a pull request requires a test prior to incorporating the change into a code base. The technical features associated with addressing this problem is the generation of the data of a prompt to a large language model that predicts whether the change is testworthy. The technical effect achieved is the accuracy in determining the testworthiness of a change without undue increased computational burden.

One of ordinary skill in the art understands that the technical effects are the purpose of a technical embodiment. The mere fact that a calculation is involved in an embodiment does not remove the presence of the technical effects or alter the concrete and technical nature of the embodiments. Operations used to create the prompt and the interactions with the large language model are understood herein as inherently digital. The human mind cannot interface directly with a CPU or network interface card, or other processor, or with RAM or other digital storage, to read or write the necessary data and perform the necessary operations on digital values in the manner disclosed herein.

The embodiments are also presumed to be capable of operating at scale, within tight timing constraints in production environments, or in testing labs for production environments as opposed to being mere thought experiments.

### CONCLUSION

A system is disclosed, comprising: one or more processors; and a memory that stores one or more programs that are configured to be executed by the one or more processors. The one or more programs including instructions to perform acts that: access a large language model trained on source code and natural language to perform a task given a prompt; detect a change to contents of a file from a pull request of a code repository; construct a prompt for the large language model to predict whether the change to the file requires a test, wherein the prompt includes a task description, a description of the changes to the file, contents of the changed file, and an answer format; and obtain from the large language model, given the prompt, a response predicting whether or not the change to the file requires a test.

In an aspect, if the response indicates to test the change, determine from the pull request whether a test exists to perform the test. In an aspect, indicate in the pull request that a test is needed and whether or not the test is available in the repository. In an aspect, the description of the change to the file includes a diff file or a diff format of the change.

In an aspect, the answer format includes a Yes response format and a No response format. In an aspect, the answer format includes an explanation for the large language model to clarify the response. In an aspect, the large language model is a neural transformer model with attention.

A computer-implemented method is disclosed comprising: detecting a change in a pull request to a file of a code repository; accessing a large language model trained on source code and natural language; creating a prompt for the large language model to predict whether a new file requires a test, wherein the prompt includes a task description, contents of the new file, and an answer format; and obtaining from the large language model, given the prompt, a response predicting whether or not the new file requires a test.

In an aspect, the computer-implemented method further comprises: when the response indicates that the new file requires a test, checking that a test exists to test the new file. In an aspect, the computer-implemented method further comprises: commenting in the pull request that the new file requires a test. In an aspect, the computer-implemented method further comprises: indicating in the pull request that the test exists for the new file.

In an aspect, the computer-implemented method further comprises: reducing portions of the contents of the new file to fit within a context window size of the large language model. In an aspect, the answer format includes a Yes or No response. In an aspect, the answer format includes an explanation of the response from the large language model. In an aspect, the large language model is a neural transformer model with attention.

A computer-implemented method is disclosed, comprising: obtaining a change from a pull request of a code repository, wherein the change alters contents of a file or creates a new file; employing a large language model to predict the testworthiness of the change, wherein the large language model is given a prompt that includes a description of the task, the change, and an answer format; receiving a response from the large language model; and upon the response indicating that the change is testworthy: checking if the pull request includes a test to cover the change; and responding to the pull request with the response and whether the test is contained in the pull request.

In an aspect, the computer-implemented method further comprises: upon the response indicating that the change is not testworthy, providing a comment in the pull request indicating that the change is not testworthy. In an aspect, the computer-implemented method further comprises: generating a suggested test for the change. In an aspect, the computer-implemented method further comprises: reducing the size of the prompt to fit within a context window size of the large language model. In an aspect, the large language model includes a neural transformer model with attention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

What is claimed:

1. A system comprising:
one or more processors; and
a memory that stores one or more programs that are configured to be executed by the one or more processors, the one or more programs including instructions to perform acts that:
access a large language model trained on source code and natural language to perform a task given a prompt;
detect a change to contents of a file from a pull request of a code repository;
construct a prompt for the large language model to predict whether the change to the file requires a test, wherein the prompt includes a task description, a description of the changes to the file, contents of the changed file, and an answer format; and
obtain from the large language model, given the prompt, a response predicting whether or not the change to the file requires a test.

2. The system of claim 1, wherein the one or more programs include instructions to perform acts that:
if the response indicates to test the change, determine from the pull request whether a test exists to perform the test.

3. The system of claim 2, wherein the one or more programs include instructions to perform acts that:
indicate in the pull request that a test is needed and whether or not the test is available in the repository.

4. The system of claim 1, wherein the description of the change to the file includes a diff file or a diff format of the change.

5. The system of claim 1, wherein the answer format includes a Yes response format and a No response format.

6. The system of claim 1, wherein the answer format includes an explanation for the large language model to clarify the response.

7. The system of claim 1, wherein the large language model is a neural transformer model with attention.

8. A computer-implemented method, comprising:
detecting a change in a pull request to a file of a code repository;
accessing a large language model trained on source code and natural language;
creating a prompt for the large language model to predict whether a new file requires a test, wherein the prompt includes a task description, contents of the new file, and an answer format; and
obtaining from the large language model, given the prompt, a response predicting whether or not the new file requires a test.

9. The computer-implemented method of claim 8, further comprising:
when the response indicates that the new file requires a test, checking that a test exists to test the new file.

10. The computer-implemented method of claim 9, further comprising:
commenting in the pull request that the new file requires a test.

11. The computer-implemented method of claim 10, further comprising:
indicating in the pull request that the test exists for the new file.

12. The computer-implemented method of claim 8, further comprising:
reducing portions of the contents of the new file to fit within a context window size of the large language model.

13. The computer-implemented method of claim 8, wherein the answer format includes a Yes or No response.

14. The computer-implemented method of claim 13, wherein the answer format includes an explanation of the response from the large language model.

15. The computer-implemented method of claim 8, wherein the large language model is a neural transformer model with attention.

16. A computer-implemented method, comprising:
obtaining a change from a pull request of a code repository, wherein the change alters contents of a file or creates a new file;
employing a large language model to predict the testworthiness of the change, wherein the large language model is given a prompt that includes a description of the task, the change, and an answer format;
receiving a response from the large language model; and
upon the response indicating that the change is testworthy:
checking if the pull request includes a test to cover the change; and
responding to the pull request with the response and whether the test is contained in the pull request.

17. The computer-implemented method of claim 16, further comprising:
upon the response indicating that the change is not testworthy, providing a comment in the pull request indicating that the change is not testworthy.

18. The computer-implemented method of claim 16, wherein upon the response indicating that the change is testworthy further comprises:
generating a suggested test for the change.

19. The computer-implemented method of claim 16, further comprising:
reducing size of the prompt to fit within a context window size of the large language model.

20. The computer-implemented method of claim 16, wherein the large language model includes a neural transformer model with attention.
